(19) United States
(12) Patent Application Publication
(10) Pub. No.: US 2026/0301754 A1
(43) Pub. Date: Oct. 1, 2026

(54) AUDIO DE-IDENTIFICATION

(71) Applicant: Microsoft Technology Licensing, LLC, Redmond, WA (US)

(72) Inventors: Dushyant SHARMA, Mountain House, CA (US); Eric CLAUSEN-BROWN, New York City, NY (US); Thomas LIN, Bellevue, WA (US); Rong GONG, Vienna (AT); Peter Avery SKALA, Vienna (AT)

(21) Appl. No.: 19/224,763

(22) Filed: May 31, 2025

Related U.S. Application Data
(60) Provisional application No. 63/781,246, filed on Mar. 31, 2025.

(51) Int. Cl. G10L 21/00; G10L 15/06; G10L 15/26; G10L 25/78

(52) U.S. Cl. CPC G10L 21/00; G10L 15/063; G10L 15/26; G10L 25/78

(57) ABSTRACT

A computerized system and method for audio de-identification is provided. An audio signal is received and its transcript is generated using a trained privacy tagged end-to-end automatic speech recognition (ASR) model. The transcript includes privacy tags indicating privacy information in the audio signal. The ASR model is trained using privacy tags and non-privacy tags surrounding words in a training transcript of a training audio signal. Audio segments corresponding to the privacy tags in the audio signal and the transcript are de-identified to generate de-identified audio signal and transcript. De-identification includes removing or replacing (with some filler or otherwise de-identified information) the privacy information in the audio segments of the audio signal and transcript. Examples of the disclosure have practical applications in various fields for de-identifying private information (e.g., patient name, unique health identification number, etc.) in an audio signal and transcript, for example associated with a doctor-patient encounter.

### CROSS-REFERENCE TO RELATED APPLICATION

This application claims priority to U.S. Provisional Patent Application No. 63/781,246, entitled “AUDIO DE-IDENTIFICATION,” filed on Mar. 31, 2025, the disclosure of which is incorporated herein by reference in its entirety.

### BACKGROUND

With the increasing adoption of voice-enabled systems and services-ranging from virtual assistants and call center analytics to medical dictation and legal transcription-large volumes of audio data are routinely collected and processed. Often, this audio data contains protected health information (PHI), personally identifiable information (PII) or other sensitive data, such as names, addresses, phone numbers, account credentials, financial details, and/or other private conversations. Automatic Speech Recognition (ASR) systems have enabled the transcription of audio signals into text, but conventional ASR systems are not inherently designed to detect or flag privacy-sensitive information. As a result, additional post-processing modules are needed to identify and remove private content, introducing latency and potential points of failure in the data processing pipeline.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for audio de-identification is described. An audio signal is received and a transcript is generated using a privacy tagged end-to-end automatic speech recognition (ASR) model. The transcript includes privacy tags indicating privacy information in the audio signal. Audio segments corresponding to the privacy tags in the audio signal and the transcript are removed to generate de-identified audio signal and transcript.

### BRIEF DESCRIPTION OF THE DRAWINGS

The present description will be better understood from the following detailed description read considering the accompanying drawings, wherein:

FIG. 1 is a block diagram illustrating an example system for generating de-identified audio and transcript from an audio signal;

FIG. 2 is a block diagram illustrating an example system for training of an automatic speech recognition (ASR) model to generate a trained privacy tagged ASR model that is used to generate de-identified audio and transcript;

FIG. 3 is a block diagram illustrating an example system for generating de-identified audio and transcript from an audio signal additionally using a language model (LM);

FIG. 4A is a flowchart illustrating an example method for generating de-identified audio and transcript from an audio signal;

FIG. 4B is a flowchart illustrating an example method for training an ASR model to generate a trained privacy tagged ASR model; and

FIG. 5 illustrates an example computing apparatus as a functional block diagram.

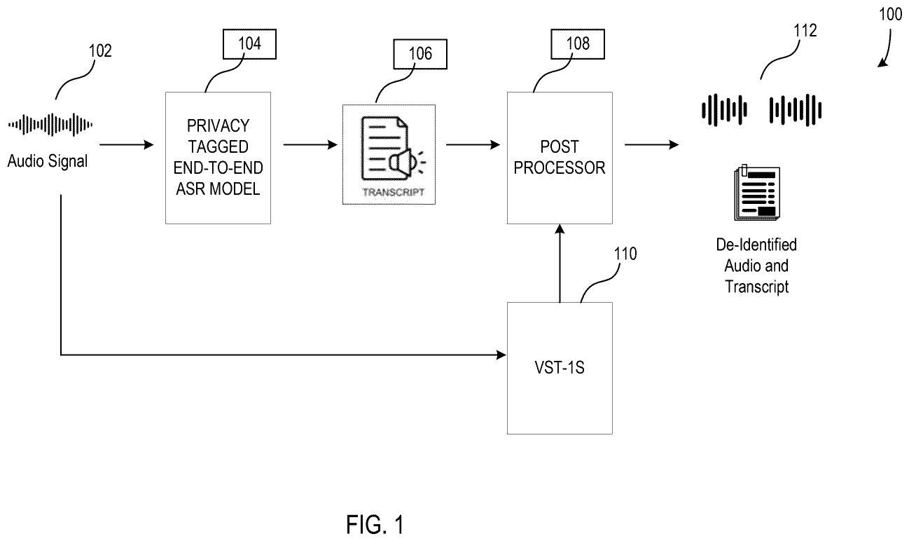

Corresponding reference characters indicate corresponding parts throughout the drawings. In FIGS. 1 to 5, the systems are illustrated as schematic drawings. The drawings may not be to scale. Any of the figures may be combined into a single example or embodiment.

### DETAILED DESCRIPTION

In the context of automatic speech recognition (ASR) based applications, secure handling of voice data is of paramount importance. Traditional ASR systems are designed to transcribe spoken content (e.g., a recorded audio signal, a live audio stream, etc.) accurately but do not recognize or protect sensitive information within the audio signal. With the widespread adoption of voice-activated systems, smart assistants, and automated transcription services, the need for privacy-preserving audio processing for audio de-identification has become increasingly critical. Many applications in healthcare, customer service, law enforcement, and personal communication involve handling sensitive audio data that may contain, for example, protected health information (PHI) and/or personally identifiable information (PII), such as names, addresses, financial details, or other private conversations. For example, when handling medical data, the issue of securing of PHI and PII components in the speech signal and transcripts are requirements for storing and/or further processing the audio data. Existing methods for audio de-identification often rely on manual redaction or predefined keyword filtering techniques that lack adaptability and accuracy, leading to incomplete or inconsistent privacy protection. PHI and PII are used interchangeably herein to refer to information that is desired to be identified and optionally removed from audio and/or a transcript. Further, while aspects of the disclosure are operable with PHI and/or PII, other aspects are operable with any category, type, or class of information to be tagged and optionally removed.

In contrast, examples of the disclosure automatically de-identify sensitive, private, and personal information in an audio signal to generate de-identified audio and transcript using a trained privacy tagged end-to-end ASR model in a PHI Tagger ASR (Phi-T-ASR) system. As described herein, de-identify refers to the identification of PHI and/or PII data, tagging of PHI and/or PII data, and/or removal of PHI and/or PII data. This disclosure addresses privacy concerns at least by using privacy-tagged end-to-end ASR models that provide an automated approach to detect, classify, and tag sensitive content within an audio stream in real time. By embedding privacy tags within the generated transcript, this method enables a systematic and structured removal of privacy-sensitive audio segments, ensuring that both the audio signal and its corresponding text representation are de-identified. This approach enhances privacy while maintaining the usability and contextual integrity of the remaining speech content.

Aspects of the disclosure are operable in various domains including, but not limited to, doctor-patient interaction and a financial conversation.

In some examples, an audio signal is received and its transcript is generated using a trained privacy tagged end-to-end ASR model. The transcript includes privacy tags encoding privacy information (e.g., names, addresses, financial details, etc.) in the audio signal. Encoding of privacy information may be represented by including the privacy tags in the transcript to indicate the presence of the privacy information in the transcript of the audio signal. Similarly, the non-privacy tags indicate the non-private information in the transcript of the audio signal. The ASR model is trained using privacy tags and non-privacy tags surrounding words in a training transcript of a training audio signal. Audio segments corresponding to the privacy tags in the audio signal and the transcript are de-identified to generate de-identified audio signal and transcript. De-identification includes removing or replacing (with filler or de-identified information) the privacy information in the audio segments of the audio signal and transcript. The de-identified audio signal and transcript may be stored and used to comply with the various data protection laws and industry standards such as Health Insurance Portability and Accountability Act (HIPAA), General Data Protection Regulation (GDPR), Personal Information Protection and Electronic Documents Act (PIPEDA), and the like.

Examples of the disclosure implement a computerized method for audio de-identification. An audio signal is received and a transcript associated with the audio signal is generated using a privacy tagged end-to-end ASR model which is generated by training an end-to-end ASR model using privacy tags and non-privacy tags surrounding words in a training transcript of a training audio signal. The transcript includes privacy tags indicating privacy information in the audio signal. The privacy tags include a plurality of types of tags (e.g., names, addresses, zip codes, and the like) for indicating the privacy information of different types in the audio signal. In some examples, encoding of all types of privacy tags may be with a single privacy tag (e.g., all_phi). Audio segments corresponding to the privacy tags in the audio signal and the transcript are removed to generate de-identified audio signal and transcript. As the privacy tagged end-to-end ASR model is a trained ASR model, it generates privacy tags and/or non-privacy tags in the transcript that is generated. Inclusion of the privacy tags and/or non-privacy tags in the transcript enables a process to execute to remove the audio segments corresponding to the privacy tags in the audio signal while maintaining the audio segments corresponding to the non-privacy tags in the audio signal.

In some examples, the voice of a speaker (or all speakers) in the audio signal is converted into another voice, such as that of a single target virtual agent speaker. In other examples, voices of speakers in the audio signal are converted into voices of different virtual agent speakers. For example, a voice of a female speaker in the audio signal is converted into a voice of a female virtual agent speaker, and a voice of a male speaker in the audio signal is converted into a voice of a male virtual agent speaker. This eliminates the possibility of identifying a speaker (e.g., a celebrity speaker) in the de-identified audio signal generated after removing the privacy information. In this example, the voice of a speaker, before or after generating the de-identified audio signal, is converted to the voice of a virtual agent speaker.

In some examples, a boundary associated with the privacy tags in the audio signal is expanded (e.g., “dilated”) by an amount of time or words (e.g., 0.5 seconds, 1 second, etc.), for example, using voice activity detection (VAD) information for expanding the boundary associated with the privacy tags in the audio signal. The VAD information guides the dilation to allow segmenting around words (e.g., before a word, after a word, or on both sides of a word) in the audio signal, ensuring complete removal of the privacy information in the de-identified audio signal. Expanding the PHI tag segment boundaries by a given amount advantageously improves the recall which means that the privacy tagged end-to-end ASR model is better at capturing all PHI occurrences instead of missing some due to segmentation errors.

In some examples, a language model (LM) is used for extracting one or more additional privacy tags from the transcript, for example, which might have been missed by the privacy tagged end-to-end ASR model. The LM may be used to combine the privacy tags in the transcript associated with the audio signal and the one or more additional privacy tags extracted from the transcript to generate a refined transcript. The de-identified audio signal and transcript are generated based on the combination of the privacy tags in the audio signal and the one or more additional privacy tags extracted from the transcript. This results in enhanced accuracy in removing the privacy information.

FIG. 1 is a block diagram illustrating an example system 100 for generating de-identified audio and transcript from an audio signal. An audio signal 102 comprising a first phrase representing privacy information and a second phrase representing non-privacy information is received. A privacy tagged end-to-end ASR model 104 is used to generate a transcript 106 associated with the audio signal, the transcript 106 including a privacy tag encoding the first phrase representing the privacy information and a non-privacy tag encoding the second phrase representing the non-privacy information. In some examples, voice(s) of speaker(s) in the audio signal 102 are converted into a voice of a single target virtual agent speaker using voice style transfer for one speaker (VST-1S) 110. The VST-1S advantageously de-identifies the voice of a celebrity speaker as well that might be easily identified even if the privacy information is removed from the audio signal. The VST system 110 converts the audio into the voice of a canonical speaker's voice, thus preserving the PII aspect of the original audio signal 102.

The post processor 108 removes a first audio segment corresponding to the privacy tag encoding the first phrase in the audio signal and the transcript to generate de-identified audio signal and transcript 112, the de-identified audio signal and transcript including a second audio segment corresponding to the non-privacy tag encoding the second phrase in the audio signal and the transcript. As the post processor 108 uses the de-identified voice of even the celebrity speakers, the de-identified audio signal and transcript 112 is highly accurate with almost negligible privacy information.

If any privacy information is later identified in the de-identified audio signal and transcript 112, this information is used for further refining or training of the privacy tagged end-to-end ASR model 104. The privacy tagged end-to-end ASR model 104 is trained using privacy tags and non-privacy tags surrounding words in a training transcript of a training audio signal.

In some examples, the post processor 108 replaces a first audio segment corresponding to the privacy tag encoding the first phrase in the audio signal with a filler audio segment (e.g., canonical voice of a virtual agent speaker) to generate de-identified audio signal, the de-identified audio signal including the filler audio segment and a second audio segment corresponding to the non-privacy tag encoding the second phrase in the audio signal. The filler audio segment may be a blank voice segment or a de-identified voice audio segment. Additionally, or alternatively, the post processor 108 generates a de-identified transcript by replacing the first phrase representing the privacy information with a filler phrase (e.g., surrogation information that changes the privacy information to something else), the de-identified transcript including the filler phrase and the second phrase representing the non-privacy information. The filler phrase may be a pause, a blank phrase, a de-identified phrase, or any other replacement phase.

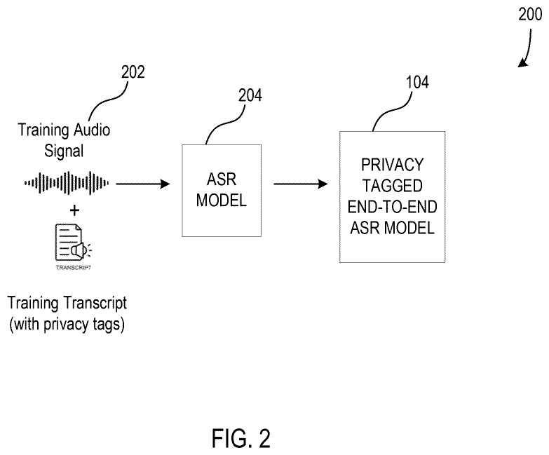

FIG. 2 is a block diagram illustrating an example system 200 for training an ASR model to generate a trained privacy tagged ASR model that is used to generate de-identified audio and transcript, such as described above at least with reference to FIG. 1. Training audio signal and/or training transcript 202 associated with the training audio signal is used to train the ASR model 204 and generate the trained privacy tagged end-to-end ASR model 104. In some examples, artificial intelligence (AI) and machine learning techniques are utilized to train the ASR models 204. In some examples, the machine learning algorithm may be those involving Transformer based encoder architectures, Convolutional Neural Network (CNN) based encoder architectures, Connectionist Temporal Classification (CTC) based decoders, beam search based decoders, Recurrent Neural Network Transducer (RNN-T) based decoders, and the like.

For example, aspects of the disclosure train an end-to-end (E2E) ASR model using PHI/No-PHI tags surrounding words (during training) which are marked in the training text or the training transcript as such. This marking indicates whether the word/phrase represents PHI or non-PHI information. Then during inference, for an exemplary audio signal “the patient name is Peter”, the system 100 produces intermediate output text or the transcript 106 in the following format:
<no-phi> the patient name is <\no-phi><phi> Peter<\phi>

Further, the system 100 outputs the de-identified audio signal 112 as “the patient name is name” that replaces the privacy information with non-privacy information or “the patient name is . . . ” that removes the privacy information. The system 100 outputs the de-identified transcript 112 in the following format:
<no-phi> the patient name is <\no-phi><phi> name<\phi>
Or <no-phi> the patient name is <\no-phi><phi> . . . <\phi>

This markup in the text/transcript is aligned to the audio provided as input to the system 100 and then a subsequent process may be run to zero out or remove the PHI component from the audio and text. The result is a de-identified audio stream and corresponding “secured” transcript 112. The metadata of the PHI type can be left in place within the de-identified transcript. In some examples, the tags may include the phi type such as no-phi, phi-name, phi-date, phi-other, and the like.

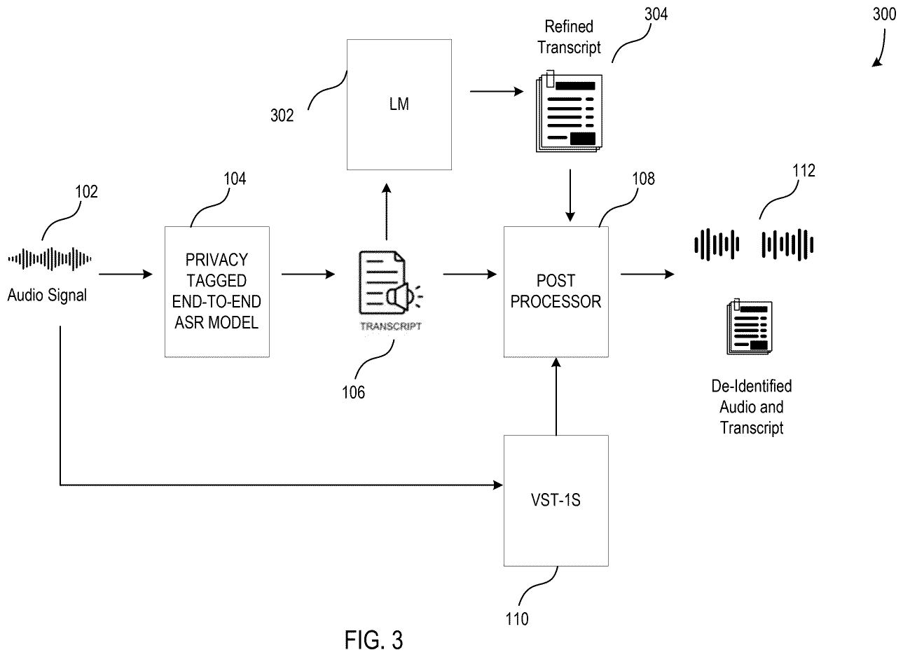

In some examples, text to speech (TTS) system is used to augment the training data to ‘boost’ the PHI data to include additional types of privacy information (e.g., names, dates, etc.). As real-world PHI data is limited and highly regulated, TTS systems can synthesize diverse PHI-containing speech samples to improve model training. In some examples, using the TTS system includes: (1) selecting PHI data sources (e.g., medical records, synthetic patient names), (2) using a TTS engine (e.g., Tacotron, VITS, FastSpeech, Amazon Polly, Google TTS, etc.), (3) generating PHI-rich audio samples and transcripts, (4) training the ASR model with real+synthetic data, and (5) evaluating improvements in PHI recognition and tagging accuracy. The use of the TTS engine increases or boosts the PHI quantity and quality which is useful for the tagged ASR training. The source material for the PHI may be selected from other corpora or may be taken from a generative AI system (e.g., to generate sentences containing PHI in the medical context, for example, “the patient name is John”). This text data may then be used to tune or train the post processor 108 and/or the LM post-processing component 302 (shown in FIG. 3).

In some examples, the ASR training process includes the use of a PHI tag based loss term to improve the model's ability to recognize and tag PHI. This ensures that PHI is explicitly learned, tagged, and processed correctly, enhancing de-identification accuracy. The PHI tag-based loss modifies the ASR training objective to explicitly penalize errors related to PHI, for example, by using PHI-Weighted Cross-Entropy Loss, PHI-Sensitive CTC (Connectionist Temporal Classification) Loss, and the like. In some examples, the total loss can be a weighted combination of the additional PHI related loss and the standard ASR loss, e.g., total_loss=alpha*wer+(1−alpha)*phi_loss. In this, WER refers to word error rate which measures how different the predicted transcript is from the reference transcript, and alpha is a weighting factor (typically between 0 and 1) that balances the two losses. The WER ensures final transcript quality and Phi loss helps optimize the acoustic model. Integrating a PHI tag-based loss term into ASR training ensures that sensitive information is explicitly identified, tagged, and redacted before storage or analysis. This approach enhances speech privacy, making ASR more robust for secure applications such as healthcare, legal, customer service transcription, etc.

FIG. 3 is a block diagram illustrating an example system 300 for generating de-identified audio and transcript from an audio signal additionally using a LM. System 300 uses an additional LM and is otherwise similar to system 100. For ease of disclosure, only the additional functionality of the system 300 is described here.

The LM 302 processes the transcript 106 to identify additional privacy tags and generate a refined transcript 304 with the additional privacy tags which are missed by the privacy tagged E2E ASR model 104. The post processor 108 uses the transcript 106, refined transcript 304 and the single target virtual agent speaker output from the VST-1S 110 to generate the de-identified audio and transcript 112.

The LM 302 uses generative AI to identify additional privacy tags or misidentified (e.g., incorrectly identified) privacy tags and/or non-privacy tags in the transcript 106 reducing missed and/or false tags. Such identification of the additional privacy tags or misidentified privacy tags and/or non-privacy tags is used for training or retraining the privacy tagged E2E ASR model 104, for example, as described above for system 200. For example, the refined transcript may be used subsequently as a learning transcript and the audio signal associated therewith as a learning audio signal.

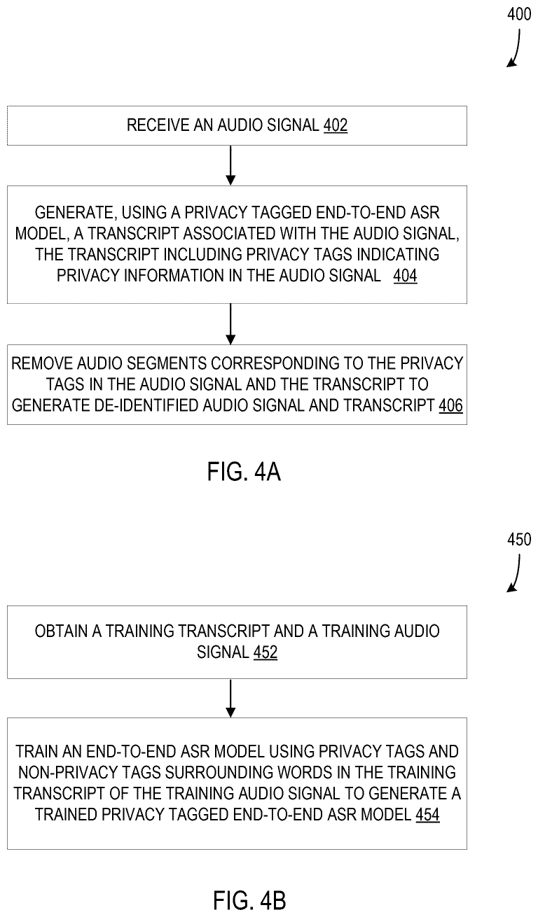

FIG. 4A is a flowchart illustrating an example method 400 for generating de-identified audio and transcript from an audio signal. At 402, an audio signal is received. At 404, a transcript associated with the audio signal is generated using a privacy tagged E2E ASR model. The transcript includes privacy tags indicating privacy information in the audio signal. At 406, audio segments corresponding to the privacy tags in the audio signal and the transcript are removed to generate de-identified audio signal and transcript.

Examples of the disclosure operate in an unconventional and advantageous manner at least by generating de-identified audio and transcript from an audio signal using an LM. Further, examples of the disclosure utilize edge LMs that are designed to run on edge devices, such as smartphones, IoT devices, and embedded systems, instead of relying on cloud-based infrastructure. By running locally on edge devices, these models provide lower latency, better privacy, and reduced dependence on constant internet connectivity.

FIG. 4B is a flowchart illustrating an example method 450 for training an ASR model to generate a trained privacy tagged ASR model. At 452, a training transcript associated with a training audio signal and/or the training audio signal are obtained. At 454, an E2E ASR model is trained using privacy tags and non-privacy tags surrounding words in the training transcript of the training audio signal to generate a trained privacy tagged E2E ASR model.

A practical application of the examples of the disclosure is in the healthcare domain to use an E2E ASR system that is trained to tag PHI vs No-PHI in the data and remove them from the audio and text transcripts, as well as the use of a voice style transfer method to alter the voice of the speaker(s) in the audio, thus achieving a de-identified audio and text transcript. This approach enables storage and use of healthcare data in a secure manner.

Examples of the disclosure add tags to each word in the transcript and train the ASR system using standard ASR pipelines. A technical advantage is that both a tag as well as the text transcription (e.g., therefore not requiring multiple processes) are obtained. In some examples, different de-identification modules may be combined (e.g., additional usage of a LM) to more effectively perform de-identification in post-processing. Further, the trained privacy tagged end-to-end ASR model of the Phi-T-ASR system is able to use both acoustic and language information in the PHI tagging.

In some examples, the ASR model itself is modified to generate a transcript with tags (e.g., privacy tags and/or no-privacy tags) directly. Thus, examples of the disclosure do not need multiple rounds of processing such as (1) generating a transcript from an audio signal, and then (2) generating tags in the transcript (e.g., by using some LM). Notably, the ASR system has both the acoustic information and the language information to generate a transcript. With the training of the ASR system to generate transcript with tags, as described herein, the trained ASR model directly generates the transcript with tags from an audio signal. This advantageously improves management of, and reduces usage of, computing and processing resources, thereby improving the technology of de-identification.

### Experimental Results

In an example implementation, “joint ASR-PHI-detection” and “ASR draft-based PHI-detection” models are combined to detect PHI in audio data. On an experimentation data set comprising transcripts of audio recordings of doctor-patient conversations, with a dilation of 1 second applied to detected PHI segments, this combined models approach achieves a word-based PHI detection recall of 95.9%, and a non-PHI word retention of 96.9%. In this example implementation, three methods are compared:
(a) PT-ASR=the privacy tagged ASR model which is a joint ASR-PHI-detection model trained on 3k hours raw (including PHI) data.
(b) ASR-LM=this model follows a 2 step approach: first ASR transcription model (trained on 8k hours data) applied to the experimentation data set, and then second by using TXT-based PHI detection model.
(c) Joint=“OR” combination of the models 1 and 2.

In the evaluation process, the word level timing information in the ground truth and hypothesized JavaScript Object Notation (JSON) transcripts are used to convert the files into Rich Transcription Time Marked (RTTM) format files. Dilation parameter controls the amount of “expansion” or dilation of each PHI segment.

Some evaluation metrics are:
(a) PHI-time: This is a time-base metrics: recall=(matched PHI time)/(reference PHI time)
(b) PHI-word: The evaluation unit is PHI word: Hits=fully hit (=100% coverage) PHI words, 0% coverage means complete miss. An example histogram shows how PHI tokens are distributed over different coverage ranges.

The test data is the experimentation data set comprising 498 encounters with ~12k PHI tokens.

The following table shows the histogram of the PHI tokens in the ground truth. As can be seen, the largest categories are Date and names. accounting together for ~79%.

| PHI-TYPE | % |
|---|---|
| LOCATION | 3.61 |
| AGE | 5.04 |
| DATE | 44.67 |
| NAMES | 34.65 |
| OTHER | 12.03 |
| SUM | 100.00 |

Processing: The conversion from JSON (reference or hypothesis) transcriptions into RTTM format ignores tokens that are marked as silent, without timing information or without a transcription/unintelligible. The number of PHI tokens with unintelligible transcription is 407 and amounts to 58 seconds of audio, which is not significant. This includes ~23% of the encounter that is not transcribed or missing a transcription in the reference transcripts. There is also some data ~0.7% that has a transcription and contain PHI but do not have timing information. These are also removed from the evaluation.

Results: In the table below, the results for detecting PHI segments are presented. Highlighted (in bold) are the results for a one second dilation.

| Method | Dilation (s) | PHI - Words(%) |
|---|---|---|
| PT-ASR | 0 | 58.5 |
| PT-ASR | 0.5 | 84.1 |
| PT-ASR | 1 | 85.0 |
| PT-ASR | 5 | 88.1 |
| PT-ASR | 10 | 90.1 |
| PT-ASR | 25 | 92.6 |
| ASR-LM | 0 | 63.2 |
| ASR-LM | 0.5 | 91.3 |
| ASR-LM | 1 | 93.0 |
| ASR-LM | 5 | 95.4 |
| ASR-LM | 10 | 96.2 |
| ASR-LM | 25 | 97.1 |
| Joint | 0 | 68.8 |
| Joint | 0.5 | 95.0 |
| Joint | 1 | 95.9 |
| Joint | 5 | 97.3 |
| Joint | 10 | 97.8 |
| Joint | 25 | 98.4 |
| Joint | 30 | 98.4 |
| Joint | 35 | 98.6 |

The missed PHI consists mainly of letters relating to names and numbers. Non PHI Retained: The non PHI words amount to ~704k in the test set and all methods with a 1 second dilation manage to retain around 97% of this data.

| Method | Dilation (s) | NON PHI Words(%) |
|---|---|---|
| PT-ASR | 0 | 99.5 |
| PT-ASR | 0.5 | 98.5 |
| PT-ASR | 1 | 97.9 |
| PT-ASR | 5 | 94.0 |
| PT-ASR | 10 | 90.1 |
| PT-ASR | 25 | 80.5 |
| ASR-LM | 0 | 99.2 |
| ASR-LM | 0.5 | 97.9 |
| ASR-LM | 1 | 97.0 |
| ASR-LM | 5 | 91.9 |
| ASR-LM | 10 | 86.9 |
| ASR-LM | 25 | 74.8 |
| Joint | 0 | 99.1 |
| Joint | 0.5 | 97.8 |
| Joint | 1 | 96.9 |
| Joint | 5 | 91.5 |
| Joint | 10 | 86.4 |
| Joint | 25 | 74.0 |
| Joint | 30 | 70.5 |
| Joint | 35 | 67.4 |

From this experimentation, the joint approach achieves a word-based PHI detection recall of around 96%, and a non-PHI word retention of around 97% for the one second dilation.

### Exemplary Operating Environment

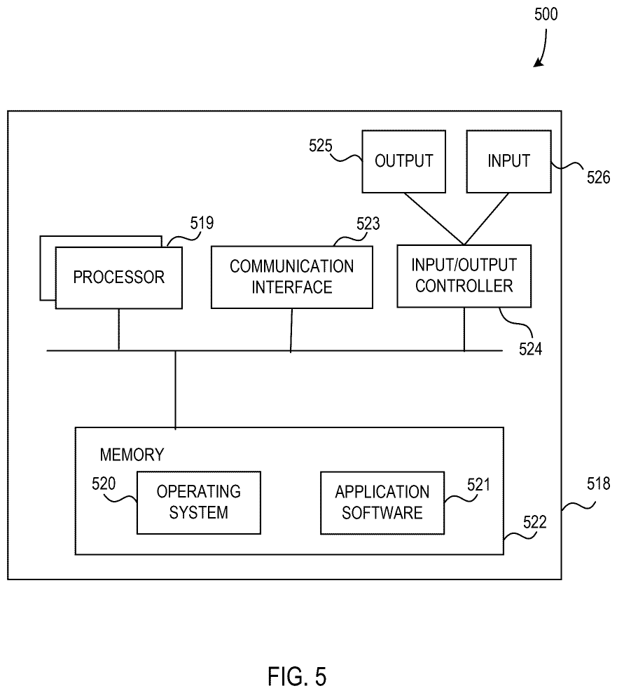

The present disclosure is operable with a computing apparatus according to an embodiment as a functional block diagram 500 in FIG. 5. In an example, components of a computing apparatus 518 are implemented as a part of an electronic device according to one or more embodiments described in this specification. The computing apparatus 518 comprises one or more processors 519 which may be microprocessors, controllers, or any other suitable type of processors for processing computer executable instructions to control the operation of the electronic device. Alternatively, or in addition, the processor 519 is any technology capable of executing logic or instructions, such as a hard-coded machine. In some examples, platform software comprising an operating system 520 or any other suitable platform software is provided on the apparatus 518 to enable application software 521 to be executed on the device. In some examples, performing audio de-identification is accomplished by software, hardware, and/or firmware.

In some examples, computer executable instructions are provided using any computer-readable media that is accessible by the computing apparatus 518. Computer-readable media include, for example, computer storage media such as a memory 522 and communications media. Computer storage media, such as a memory 522, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 522) is shown within the computing apparatus 518, it will be appreciated by a person skilled in the art, that, in some examples, the storage is distributed or located remotely and accessed via a network or other communication link (e.g., using a communication interface 523).

Further, in some examples, the computing apparatus 518 comprises an input/output controller 524 configured to output information to one or more output devices 525, for example a display or a speaker, which are separate from or integral to the electronic device. Additionally, or alternatively, the input/output controller 524 is configured to receive and process an input from one or more input devices 526, for example, a keyboard, a microphone, or a touchpad. In one example, the output device 525 also acts as the input device. An example of such a device is a touch sensitive display. The input/output controller 524 may also output data to devices other than the output device, e.g., a locally connected printing device. In some examples, a user provides input to the input device(s) 526 and/or receives output from the output device(s) 525.

The functionality described herein can be performed, at least in part, by one or more hardware logic components. According to an embodiment, the computing apparatus 518 is configured by the program code when executed by the processor 519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example method performs audio de-identification. The computerized method comprises: receiving an audio signal; generating, using a privacy tagged end-to-end automatic speech recognition (ASR) model, a transcript associated with the audio signal, the transcript including privacy tags indicating privacy information in the audio signal; and removing audio segments corresponding to the privacy tags in the audio signal and the transcript to generate de-identified audio signal and transcript.

An example method trains an ASR model. The computerized method comprises: obtaining a training audio signal and a training transcript associated with the training audio signal, the training audio signal being without privacy information and the training transcript including privacy tags indicating the privacy information; and training the ASR model using the obtained training audio signal and the training transcript to generate a trained ASR model, wherein the trained ASR model is configured to de-identify the privacy information in an audio signal and a transcript associated with the audio signal.

An example system for audio de-identification comprises: a processor; and a memory storing instructions that upon execution by the processor cause the processor to: receive an audio signal comprising a first phrase representing privacy information and a second phrase representing non-privacy information; generate, using a privacy tagged end-to-end automatic speech recognition (ASR) model, a transcript associated with the audio signal, the transcript including a privacy tag encoding the first phrase representing the privacy information and a non-privacy tag encoding the second phrase representing the non-privacy information; and remove a first audio segment corresponding to the privacy tag encoding the first phrase in the audio signal and the transcript to generate de-identified audio signal and transcript, the de-identified audio signal and transcript including a second audio segment corresponding to the non-privacy tag encoding the second phrase in the audio signal and the transcript.

An example computer storage medium stores instructions that upon execution by a processor cause the processor to: receive an audio signal comprising a first phrase representing privacy information and a second phrase representing non-privacy information; generate, using a privacy tagged end-to-end automatic speech recognition (ASR) model, a transcript associated with the audio signal, the transcript including a privacy tag encoding the first phrase representing the privacy information and a non-privacy tag encoding the second phrase representing the non-privacy information; and replace a first audio segment corresponding to the privacy tag encoding the first phrase in the audio signal with a filler audio segment to generate de-identified audio signal, the de-identified audio signal including the filler audio segment and a second audio segment corresponding to the non-privacy tag encoding the second phrase in the audio signal

Alternatively, or in addition to the other examples described herein, examples include any combination of the following:
training an end-to-end ASR model using privacy tags and non-privacy tags surrounding words in a training transcript of a training audio signal to generate a trained privacy tagged end-to-end ASR model; and generating the transcript associated with the audio signal using the trained privacy tagged end-to-end ASR model.
converting voice of a speaker in the audio signal into voice of a single target virtual agent speaker.
wherein the de-identified audio signal includes the voice of the single target virtual agent speaker.
wherein the privacy tags include a plurality of types of tags for indicating the privacy information of different types in the audio signal.
expanding boundary associated with the privacy tags in the audio signal by a predetermined amount.
using voice activity detection (VAD) in the audio signal for expanding the boundary associated with the privacy tags in the audio signal.
extracting, using an LM, one or more additional privacy tags from the transcript; combining, using the LM, the privacy tags in the transcript associated with the audio signal and the one or more additional privacy tags extracted from the transcript; and generating the de-identified audio signal and transcript based on the combination of the privacy tags in the audio signal and the one or more additional privacy tags extracted from the transcript.
wherein the transcript further includes a non-privacy tag indicating non-privacy information in the audio signal, wherein the de-identified audio signal and transcript includes the non-privacy information corresponding to the non-privacy tag in the audio signal and the transcript.
wherein the privacy tagged end-to-end ASR model is trained using privacy tags and non-privacy tags surrounding words in a training transcript of a training audio signal.
wherein the instructions upon execution by the processor cause the processor to convert voice of a speaker in the audio signal into voice of a single target virtual agent speaker.
wherein the de-identified audio signal includes the voice of the single target virtual agent speaker.
wherein the privacy tag includes a plurality of types of tags for encoding the privacy information of different types in the audio signal.
wherein the instructions upon execution by the processor cause the processor to expand boundary associated with the privacy tag in the audio signal by a predetermined amount using voice activity detection (VAD) in the audio signal.
wherein the instructions upon execution by the processor cause the processor to generate a de-identified transcript by replacing the first phrase representing the privacy information with a filler phrase, the de-identified transcript including the filler phrase and the second phrase representing the non-privacy information.
wherein the privacy tagged end-to-end ASR model is trained using privacy tags and non-privacy tags surrounding words in a training transcript of a training audio signal.
wherein the instructions upon execution by the processor cause the processor to convert the second audio segment in the audio signal into voice of a single target virtual agent speaker, wherein the filler audio segment and the second audio segment in the de-identified audio signal are in the voice of the single target virtual agent speaker.
wherein the instructions upon execution by the processor cause the processor to expand boundary associated with the privacy tag in the audio signal by a predetermined amount using voice activity detection (VAD) in the audio signal.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for audio de-identification comprising: an exemplary means for receiving an audio signal; an exemplary means for generating, using a privacy tagged end-to-end automatic speech recognition (ASR) model, a transcript associated with the audio signal, the transcript including privacy tags indicating privacy information in the audio signal; and an exemplary means for removing audio segments corresponding to the privacy tags in the audio signal and the transcript to generate de-identified audio signal and transcript.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for audio de-identification comprising:
a processor; and
a memory storing instructions that upon execution by the processor cause the processor to:
receive an audio signal comprising a first phrase representing privacy information and a second phrase representing non-privacy information;
generate, using a privacy tagged end-to-end automatic speech recognition (ASR) model, a transcript associated with the audio signal, the transcript including a privacy tag encoding the first phrase representing the privacy information and a non-privacy tag encoding the second phrase representing the non-privacy information; and
remove a first audio segment corresponding to the privacy tag encoding the first phrase in the audio signal and the transcript to generate de-identified audio signal and transcript, the de-identified audio signal and transcript including a second audio segment corresponding to the non-privacy tag encoding the second phrase in the audio signal and the transcript.

2. The system of claim 1, wherein the privacy tagged end-to-end ASR model is trained using privacy tags and non-privacy tags surrounding words in a training transcript of a training audio signal.

3. The system of claim 1, wherein the instructions upon execution by the processor cause the processor to convert a voice of a speaker in the audio signal into a voice of a single target virtual agent speaker.

4. The system of claim 3, wherein the de-identified audio signal includes the voice of the single target virtual agent speaker.

5. The system of claim 1, wherein the privacy tag includes a plurality of types of tags for encoding the privacy information of different types in the audio signal.

6. The system of claim 1, wherein the instructions upon execution by the processor cause the processor to expand a boundary associated with the privacy tag in the audio signal by an amount using voice activity detection (VAD) in the audio signal.

7. A computerized method for audio de-identification comprising:
receiving an audio signal;
generating, using a privacy tagged end-to-end automatic speech recognition (ASR) model, a transcript associated with the audio signal, the transcript including privacy tags indicating privacy information in the audio signal; and
removing audio segments corresponding to the privacy tags in the audio signal and the transcript to generate de-identified audio signal and transcript.

8. The computerized method of claim 7, further comprising:
training an end-to-end ASR model using privacy tags and non-privacy tags surrounding words in a training transcript of a training audio signal to generate a trained privacy tagged end-to-end ASR model; and
generating the transcript associated with the audio signal using the trained privacy tagged end-to-end ASR model.

9. The computerized method of claim 7, further comprising converting a voice of a speaker in the audio signal into a voice of a single target virtual agent speaker.

10. The computerized method of claim 9, wherein the de-identified audio signal includes the voice of the single target virtual agent speaker.

11. The computerized method of claim 7, wherein the privacy tags include a plurality of types of tags for indicating the privacy information of different types in the audio signal.

12. The computerized method of claim 7, further comprising expanding a boundary associated with the privacy tags in the audio signal by an amount.

13. The computerized method of claim 12, further comprising using voice activity detection (VAD) in the audio signal for expanding the boundary associated with the privacy tags in the audio signal.

14. The computerized method of claim 7, further comprising:
extracting, using a language model (LM), one or more additional privacy tags from the transcript;
combining, using the LM, the privacy tags in the transcript associated with the audio signal and the one or more additional privacy tags extracted from the transcript; and
generating the de-identified audio signal and transcript based on the combination of the privacy tags in the audio signal and the one or more additional privacy tags extracted from the transcript.

15. The computerized method of claim 7, wherein the transcript further includes a non-privacy tag indicating non-privacy information in the audio signal, wherein the de-identified audio signal and transcript includes the non-privacy information corresponding to the non-privacy tag in the audio signal and the transcript.

16. A computer storage medium storing instructions that upon execution by a processor cause the processor to:
receive an audio signal comprising a first phrase representing privacy information and a second phrase representing non-privacy information;
generate, using a privacy tagged end-to-end automatic speech recognition (ASR) model, a transcript associated with the audio signal, the transcript including a privacy tag encoding the first phrase representing the privacy information and a non-privacy tag encoding the second phrase representing the non-privacy information; and
replace a first audio segment corresponding to the privacy tag encoding the first phrase in the audio signal with a filler audio segment to generate de-identified audio signal, the de-identified audio signal including the filler audio segment and a second audio segment corresponding to the non-privacy tag encoding the second phrase in the audio signal.

17. The computer storage medium of claim 16, wherein the instructions upon execution by the processor cause the processor to generate a de-identified transcript by replacing the first phrase representing the privacy information with a filler phrase, the de-identified transcript including the filler phrase and the second phrase representing the non-privacy information.

18. The computer storage medium of claim 16, wherein the privacy tagged end-to-end ASR model is trained using privacy tags and non-privacy tags surrounding words in a training transcript of a training audio signal.

19. The computer storage medium of claim 15, wherein the instructions upon execution by the processor cause the processor to convert the second audio segment in the audio signal into a voice of a single target virtual agent speaker, wherein the filler audio segment and the second audio segment in the de-identified audio signal are in the voice of the single target virtual agent speaker.

20. The computer storage medium of claim 16, wherein the instructions upon execution by the processor cause the processor to expand boundary associated with the privacy tag in the audio signal by an amount using voice activity detection (VAD) in the audio signal.
